(19) United States
(12) Patent Application Publication
(10) Pub. No.: US 2012/0288649 A1
(43) Pub. Date: Nov. 15, 2012

(54) FRICTION REDUCING COATINGS

(76) Inventors: William Blackwood, Midland, MI (US); Seiji Hori, Ichihara-shi (JP); Kazuhiko Kojima, Ichihara-shi (JP); Tsugio Nozoe, Ichihara-shi (JP); Masaru Ozaki, Ichihara-shi (JP); Yuichi Tsuji, Ichihara-shi (JP)

(21) Appl. No.: 13/519,869

(22) PCT Filed: Dec. 27, 2010
(86) PCT No.: PCT/US10/62157

§ 371 Date: Jun. 28, 2012

Related U.S. Application Data
(60) Provisional application No. 61/290,934, filed on Dec. 30, 2009.

(51) Int. Cl. C10M 103/06; B05D 1/36; B32B 1/00

(52) U.S. Cl. 428/35.2; 427/412; 508/143; 508/141

(57) ABSTRACT

An aqueous coating composition for reducing friction and/or blocking at a surface, said composition comprising a solid lubricant and a modified or synthetic clay mineral having thickening properties such that a 2% by weight aqueous dispersion of the modified or synthetic clay mineral thickener has a viscosity of at least 1000 mPa·s. Preferred clay minerals used as thickeners are preferably smectite clays such as saponite, hectorite, stevensite, sauconite, bentonite, beidellite, nontronite, or montmorillonite.

This invention relates to antifriction coatings designed to be applied to a surface to reduce friction at that surface. In particular it relates to friction reducing coating compositions suitable for applying as a top coat on air bags and air bag fabrics which have been coated with an elastomeric base coat.

Air bags are generally formed from a woven or knitted fabric made of synthetic fibre, for example of polyamide such as nylon-6,6 or polyester, covered on at least one of its sides with a layer of an elastomer. Air bags may be made of flat fabric pieces which are coated and then sewn together to provide sufficient mechanical strength, or may be woven in one piece with integrally woven seams. Sewn air bags are generally assembled with the coated fabric surface at the inside of the air bag. One piece woven air bags are coated on the outside of the air bag. A preferred elastomer for coating the air bag or air bag fabric is a silicone elastomer which is a cured organopolysiloxane composition, particularly a silicone rubber coating cured by hydrosilylation, that is by the reaction of alkenyl groups of one polyorganosiloxane and Si—H groups of another silicon containing material such as a polyorganosiloxane or silane.

Alternative elastomers for coating the air bag or air bag fabric are organic resin elastomers, including urethane polymers. By an ‘organic resin’ or ‘organic polymer’ we mean a polymer in which at least 50% of the atoms forming the polymer chain are carbon atoms.

U.S. Pat. No. 5,110,666 describes a fabric substrate which is coated with a novel polycarbonate-polyether polyurethane for use as a driver's side or passenger side air bag.

U.S. Pat. No. 6,169,043 describes airbag coating compositions comprising a mix of polyurethane and polyacrylate constituents to provide a low permeability coating on a fabric surface.

U.S. Pat. No. 7,543,843 describes the use of hybrid resins as airbag coatings. The hybrid resins are urethanes blended with acrylates, vinyls, and/or silicones, where at least one of the components has a glass transition temperature of 20° C. or less. The urethanes are preferably of the polycarbonate, polytetramethyleneglycol, silicon-based diol, or olefin-based diol type.

Air bags coated with a silicone elastomer are described in many published patents and applications, for example U.S. Pat. Nos. 5,789,084, 5,877,256, 6,709,752, 6,425,600 and 6,511,754, and WO-A-08/020,605 and WO-A-08/020,635.

If an elastomer base coat is left as the only coating on the air bag, the surface properties of this base coat would result in blocking (the elastomer coated surfaces sticking to each other during storage and tight packing of the air bag in the automobile, particularly at high ambient temperatures) and very high stresses when the airbag is inflated which would result in bag failure by tearing during inflation or by delamination of the elastomer base coat from the fabric. Blocking between elastomer surfaces is also a problem during manufacture of air bags when fabric coated with elastomer is stored in a roll. Additionally, many elastomers such as silicone elastomer coatings have a high surface friction when cured.

Moreover, it has been found that the application of a curable liquid silicone rubber top coat over certain organic resin base coats, particularly urethane polymer base coats or base coats cured with an amino resin, releases a displeasing fishy smell.

U.S. Pat. No. 5,945,185 describes an air bag made of silicone modified thermoplastic polyurethane resin in which the content of siloxane is 5-40% by weight. Such an air bag is claimed to have reduced danger of blocking, but vehicle manufacturers have preferred to use coated fabric air bags.

U.S. Pat. No. 6,239,046 describes coating a knit, woven, or non-woven textile substrate with an adhesive polyurethane layer and then with an elastomeric polysiloxane layer. An air curtain or air bag with superior air-holding and superior heat resistance is then formed from the coated textile substrate.

U.S. Pat. No. 6,177,365 and U.S. Pat. No. 6,177,366 describe airbag coatings comprising at least two separate layers. The first layer (base coat), in contact with the airbag surface, comprises a non-silicone composition of polyurethane, polyacrylate, polyamide, butyl rubber, hydrogenated nitrite rubber or ethylene vinyl acetate copolymer. The second layer (topcoat) is a silicone material.

U.S. Pat. No. 6,177,366 describes airbag coating compositions comprising at least two separate and distinct layers. The first layer (base coat), being in contact with the airbag surface, comprises a silicone elastomer. The second layer (topcoat) is preferably a silicone resin.

U.S. Pat. No. 7,198,854 describes an anti-friction silicone varnish for textiles coated with silicone elastomers. The varnish comprises a crosslinkable silicone composition containing two silicones which react with one another in the presence of a catalyst to allow crosslinking, and a particulate component comprising powdered (co)polyamides.

JP-A-2004-167556 discloses an aqueous metal casting mould coating agent comprising diatomaceous earth as a thermal insulating agent, talc as a release agent, and bentonite as a binder.

An aqueous coating composition according to the present invention for reducing friction and/or blocking at a surface comprises a solid lubricant and a modified or synthetic clay mineral having thickening properties such that a 2% by weight aqueous dispersion of the modified or synthetic clay mineral thickener has a viscosity of at least 1000 mPa·s. The viscosity is measured at 25° C., at 1 s⁻¹ shear rate using a Wells-Brookfield Cone/Plate Viscometer with 20 mm diameter 2° taper cone (ASTM D4287). Unless otherwise indicated the viscosities given for all aqueous dispersions of the modified or synthetic clay mineral thickeners described herein were measured in the same manner as described above.

The invention also includes an air bag coated with an anti-blocking coating comprising a solid lubricant and a modified or synthetic clay mineral having thickening properties such that a 2% by weight aqueous dispersion of the modified or synthetic clay mineral thickener has a viscosity of at least 1000 mPa·s at 25° C., and a water soluble organic polymer.

The invention further includes a process of coating a substrate to reduce friction and/or blocking, wherein the substrate is coated with an aqueous coating composition comprising a solid lubricant and a modified or synthetic clay mineral having thickening properties such that a 2% by weight aqueous dispersion of the modified or synthetic clay mineral thickener has a viscosity of at least 1000 mPa·s at 25° C.

The solid lubricant preferably comprises a phyllosilicate, otherwise known as a sheet silicate. Examples of phyllosilicates which are suitable for use as solid lubricants in the present invention include mica, talc, for example talc microspheres, kaolinite, smectite, sericite and chlorite. Talc is widely available and is effective as a lubricant. Chlorite is also effective as a lubricant and has the advantage that it can be dispersed in water more easily than talc. The solid lubricant can additionally or alternatively comprise a fluoropolymer such as polytetrafluoroethylene (PTFE), a solid hydrocarbon wax such as a polyolefin wax, for example micronised polypropylene wax, or a mixture of PTFE and wax, or molybdenum disulphide, graphite, zinc sulfide or tricalcium phosphate, or a mixture of any two or more of these.

The solid lubricant is preferably present at least 1% by weight of the aqueous coating composition, alternatively at least 3%, for example from 5 or 10 up to 40% by weight of the aqueous coating composition.

The clay mineral used as thickener is preferably a smectite clay such as saponite, hectorite, stevensite, sauconite, bentonite, beidellite, nontronite, or montmorillonite.

According to one preferred aspect of the invention the clay mineral is modified by a water soluble organic polymer. Suitable water soluble organic polymers include polymers containing carboxylate groups, for example carboxyl-containing addition polymers such as sodium polyacrylate or sodium polymethacrylate.

The clay mineral, for example bentonite or montmorillonite, can be modified by premixing with the water soluble organic polymer. For example, the clay mineral and the water soluble organic polymer can be uniformly mixed in water, followed by drying the mixture, for example by spray drying. The resulting dried mixture can be ground if necessary to the desired particle size, which may be in the range 1 to 20 μm. The content of water soluble polymer in such a mixture may for example be in the range of 0.1 wt % to 40 wt %.

Alternatively the clay mineral such as bentonite or montmorillonite can be modified by treatment with an alkylalkoxysilane. The alkylalkoxysilane is preferably an alkyltrialkoxysilane such as methyltrimethoxysilane, ethyltrimethoxysilane, methyltriethoxysilane or ethyltriethoxysilane. The alkylalkoxysilane can for example be applied to the clay mineral as a pure liquid silane or as a solution in an organic solvent.

More than one process can be used to modify the clay mineral to make its aqueous solution more viscous. For example, a composite of bentonite or montmorillonite with a water soluble polymer can be treated with an alkylalkoxysilane

According to another aspect of the invention, the clay mineral thickener can be an artificially synthesized smectite, such as artificially synthesized saponite, artificially synthesized hectorite, and artificially synthesized stevensite. Synthetic saponite is produced by Kunimine Industries Co., Ltd. by hydrothermal synthesis of chemicals within autoclaves. The synthetic saponite is a snow-white powder, and its gel is colourless, transparent, and highly viscous relative to natural smectite gel. Examples of commercially available synthetic hectorite include B, RD, and XLG products produced by Laponite Industries Ltd. under the Laponite brand name. An example of commercially available synthetic stevensite is produced by Mizusawa Chemical Industries Ltd. under the lonite brand name. These products are white powders, and readily form either sols or gels upon addition to water. Such synthetic smectites generally have smaller particle size than natural smectites, for example an average particle diameter only 5 or 10% of the average particle diameter of natural smectites. Such smaller particle size of synthetic smectites may be a reason why they can make aqueous compositions viscous in smaller amount of addition.

A synthetic clay mineral can be modified to make its aqueous solution more viscous, although this is not usually necessary. For example a synthetic saponite, hectorite or stevensite can be treated with an alkylalkoxysilane.

The modified or synthetic clay mineral thickener can for example be present at from 0.1 or 0.2% by weight of the coating composition up to 5 or 10% by weight. Aqueous coating compositions comprising 0.5 to 3% modified or synthetic clay mineral thickener are often preferred.

The aqueous coating composition generally requires an organic polymer binder to enhance the adhesion of the solid lubricant to a substrate such as an air bag fabric. If a water soluble organic polymer is present in the coating composition, for example if the clay mineral thickener is modified with a water soluble polymer, that water soluble polymer may also act as the organic polymer binder of the coating composition. Alternatively the coating composition for reducing friction and/or blocking at a surface further comprises an organic polymer binder present in aqueous dispersion. The coating present on the substrate surface thus comprises a solid lubricant dispersed in an organic polymer binder, which can consist wholly or partly of a water soluble organic polymer or can be an organic polymer dispersed in the aqueous composition.

Preferred organic polymer binders include polyurethanes, phenolic resins, epoxy resins, acrylic resins, acrylic-modified polyolefin resins, polyester resins, amino-formaldehyde resins, vinyl resins, for example polyvinyl butyral, and polyamideimide resins. Preferred polyurethanes include copolymers of a polyester or polyether polyol and an aromatic or aliphatic diisocyanate. The level of organic polymer binder can for example be in the range 0.2 or 0.3% up to 30% by weight of the top coating composition. Levels of organic polymer binder of for example 5% up to 20% by weight of the coating composition are often preferred. For the sake of clarification, it is to be understood that where % values are provided the total amount of e.g. the composition always adds up to 100%.

Alternatively the binder may be a suitable silicone based emulsion which is curable to an elastomeric product. The dispersed phase may comprise for example a suitable hydroxylated polydiorganosiloxane and an emulsifying agent in an aqueous continuous phase, the composition may additionally comprise e.g. a suitable silica reinforcing filler such as, a colloidal silica and other ingredients such as organic tin compounds. Compositions of this type are described in U.S. Pat. No. 4,221,688 the content of which is included herein by reference. Alternatively the binder may be made from a siloxane based polymer and a suitable self catalysing cross-linker a surfactant and water. Compositions of this type are described, for example, U.S. Pat. No. 5,994,459, the content of which is enclosed herewith by reference.

The dry coating present on a substrate to reduce friction and/or blocking according to the invention can for example comprise 50 to 95% by weight solid lubricant, 2 to 15% by weight modified or synthetic clay mineral thickener and up to 45% by weight organic polymer binder. Reference to ranges in the composition on a dry coating or dry coat weight basis is intended to mean the weight calculated to exclude the weight of the water and/or any other solvent.

The coating composition for reducing friction and/or blocking may contain a flame retardant. For example, it is important that air bags do not support burning, and the air bag generally requires addition of a flame retardant in order to pass the stringent flammability tests applicable to air bags. We have found that there is generally no flammability problem when the top coat of the present invention is applied over a silicone coated air bag, but when a top coat containing no flame retardant is applied to an air bag coated with organic resin it may not pass flammability tests such as US Federal Motor Vehicles Safety Standards Test FMVSS#302 (henceforth referred to as “FMVSS#302”). The flame retardant may be most effective if it is in the top coat. An example of a preferred flame retardant is aluminum trihydrate, which preferably has not been surface treated. The antifriction coating composition can for example contain 2 to 40%, preferably 5 to 25% by weight aluminum trihydrate. Alternative flame retardants include other metal hydroxides, such as magnesium hydroxide, metal oxides, such as ferrite oxide and titanium oxide, carbonates such as zinc carbonate, and carbon blacks.

The coating composition for reducing friction and/or blocking may optionally contain a pigment, a die, an antistatic agent, a surfactant, an antiseptic, an adhesion promoter, and/or an odour eliminating agent, such as zeolite or active charcoal.

The coating composition for reducing friction and/or blocking can be applied to a substrate by a variety of techniques. Different substrates may require different coating methods. For example, the coating can be applied as a top coat to a coated air bag or coated air bag fabric by roller application, for example gravure, offset roller or lick roller, or by curtain coating, or by spray, which may be air assisted or airless spraying, or by knife over roller. Roller application is often preferred as an effective method to coat uniformly at low coating weights. The amount of coating composition transferred to the fabric is a function of pressure on the roller and/or etched surface depth in the gravure. The top coating is preferably applied at a coating weight of 0.5 or 1 g/m² up to 10 or 15 g/m² on a dry weight basis. Coating weights as low as 1 or 2 g/m² can give the required low coefficient of friction and prevent blocking.

The amount of aqueous diluent (water plus any cosolvent mixed with the water) in the antifriction coating composition can be controlled in accordance with the required viscosity for coating and the required coating weight. Usually the coating composition has a solids content of 1.5 to 50% by weight and comprises 98.5 to 50% aqueous diluent.

The coating composition of the invention can in general be applied to any substrate where reduced friction and/or reduced blocking is required. The coating composition is particularly effective when applied as a top coat on air bags or for other similar applications such as emergency chutes on aeroplanes and hot air balloons, but can also be used in other applications such as key pads, mould making, wire coating, and in improving handling in moulding processes such as a silicone moulding process.

When the coating composition, of the invention is applied as a top coat to a coated air bag or coated air bag fabric, the base coat can be any of those described in the aforementioned patents. The base coat can be an organopolysiloxane composition preferably comprising an organopolysiloxane having aliphatically unsaturated hydrocarbon or hydrocarbonoxy substituents, an organosilicon crosslinker having at least 3 silicon-bonded hydrogen atoms, a catalyst able to promote the reaction of the aliphatically unsaturated hydrocarbon or hydrocarbonoxy substituents with Si—H groups and a reinforcing filler. Such a base coat is highly flexible and effective in sealing the air bag but has a high coefficient of friction.

The base coat on the air bag or air bag fabric can alternatively be any of the organic resin based coatings described in the aforementioned patents. One preferred type of organic resin is a polyurethane. A polyurethane base coat can be a reactive polyurethane which is cured on the fabric, for example by reaction of isocyanate groups with hydroxyl or amine groups or can be a thermoplastic polyurethane. Whether curable or thermoplastic, the polyurethane is generally the reaction product of a polyol with a polyisocyanate. The polyol can for example be a polyether diol such as a polytetramethyleneglycol diol, a polyester-polyetherdiol, a polycarbonate-polyether dial, a silicone-polyether diol, or a polyacrylate containing pendant hydroxyl groups. The polyisocyanate can be an aromatic diisocyanate but is preferably an aliphatic or cycloaliphatic diisocyanate. The organic resin base coat can be a hybrid urethane resin comprising polyurethane blended with acrylates, vinyls, and/or silicones as described in U.S. Pat. No. 7,543,843. Such a hybrid urethane resin requires a top coat to inhibit blocking, that is sticking of the coated surfaces to each other during storage or tight packing in the air bag compartment of a vehicle. Although such an organic resin base coat has given odour problems when overcoated with various top coats, we have found that it can be overcoated with an anti-blocking coating according to this invention without any odour problem.

The base coat can alternatively comprise a polyacrylate, for example a curable polyacrylate containing pendant hydroxyl groups that can be cured by an amino resin such as a melamine-formaldehyde resin, or an ethylene vinyl acetate copolymer. The base coat can be a blend of organic resins, for example a blend of a polyurethane with a polyacrylate or with an ethylene vinyl acetate copolymer.

If the base coat is curable, it is generally cured before application of the top coating, although in an alternative process the coating composition for reducing friction and/or blocking can be applied to an uncured base coat and the combination of the base coat composition and the coating composition for reducing friction and/or blocking can be heat cured.

When the coating for reducing friction and/or blocking is applied to a cured base coat, the coating for reducing friction and/or blocking can be cured at ambient temperature or can be cured more rapidly at elevated temperature, for example in the range 50 to 200° C., particularly 100 to 150° C. One possible method of curing at elevated temperature comprises applying the coating composition for reducing friction and/or blocking to a heated substrate, for example to a coated air bag or air bag fabric immediately after heat curing the base coat.

The coating of the invention provides a low friction surface on the substrate to which it is applied. When applied over a coating having a high coefficient of friction, the coating of the invention reduces friction at the coated air bag surface and thus reduces wear of the air bag when it is subjected to movement when a vehicle is in use; such wear may result in reduced pressure retention of the air bag.

The coatings of the invention also inhibit blocking of the coated fabric surfaces, that is sticking of the coated surfaces to each other during storage or tight packing in the air bag compartment of a vehicle. Such blocking can cause very high stresses when the airbag is inflated, resulting in bag failure by tearing or by delamination of the silicone base coat from the fabric.

Use of the coatings of the invention as an air bag top coat does not give rise to any displeasing smell. We have found that when the coating of the invention is applied over a urethane polymer base coat, for example a hybrid urethane resin comprising urethane polymer blended with acrylates, vinyls, and/or silicones as described in U.S. Pat. No. 7,543,843, no fishy or ammoniacal smell is released.

The invention is illustrated by the following Examples, in which parts and percentages are by weight unless otherwise stated

### EXAMPLES 1 TO 4

These Examples used a modified clay mineral thickener MCT1 comprising bentonite and sodium polyacrylate, formed by uniformly mixing bentonite into an aqueous solution of sodium polyacrylate, drying the mixture, and then grinding. MCT1 had a mixture of sodium carbonate and polyacrylate content of about 15%. A 2% aqueous solution of MCT1 had a viscosity of 20,000 mPa·s, measured at 25° C., at 1 s⁻¹ shear rate using a Wells-Brookfield Cone/Plate Viscometer with 20 mm diameter 2° taper cone (ASTM D4287).

In Examples 1 and 2, MCT1 was dispersed in water and a solid lubricant (talc or chlorite) was dispersed in the resulting dispersion.

In Example 3, a polyurethane emulsion PU1 was diluted with water and MCT1 and talc was dispersed in the diluted emulsion. PU1 is an aliphatic-polyester type polyurethane self-crosslinking emulsion having a solids content of 32% and a viscosity of 400 mPa·s, measured as described above.

In Example 4, a modified polyolefin PO1 was diluted with water and MCT1 and talc was dispersed in the diluted emulsion. PO1 is an emulsion of polyolefin modified with acrylic resin and has a solids content of 30% and a viscosity of 500 mPa·s, measured as described above.

The formulations of the resulting top coat compositions are shown in Table 1.

### EXAMPLES 5 TO 7

These Examples used a modified clay mineral thickener MCT2 comprising bentonite treated with alkyltrialkoxysilane (Betonite SH: product name of Hojun Co., Ltd.). A 2% aqueous solution of MCT2 had a viscosity of 4,300 mPa·s, measured as described above.

In Example 5, MCT2 was dispersed in water and chlorite was dispersed in the resulting dispersion. In Examples 6 and 7, PU1 was diluted with water and MCT1 and talc or chlorite was dispersed in the diluted emulsion. The formulations of the resulting top coat compositions are shown in Table 1.

### EXAMPLE 8

This Example used as clay mineral thickener artificial saponite, a product of Kunimine Industry of Tokyo, Japan sold under the trade mark Sumecton SA. A 2% aqueous solution of Sumecton SA had a viscosity of 7,600 mPa·s, measured as described above. PU1 was diluted with water and Sumecton SA was dispersed in the diluted emulsion. The formulation of the resulting top coat composition is shown in Table 1.

In each of Examples 1 to 8, the ingredients were mixed and left at rest for 1 day. The stability of the mixtures were observed visually and noted in Table 1. “NG” means separation of solid ingredient was observed.

The coating compositions of each of Examples 1 to 8 were applied onto the surface of a silicone rubber by knife coating (1-10 g/m²). The uniformity of coating layer was observed visually. If the coating covered the silicone rubber uniformly, it is rated in Table 1 as uniform; if the coating could not cover the silicone rubber uniformly it is rated in Table 1 as patchy. The coating layer was dried at 180° C. for 10 seconds.

The silicone rubber having the overcoat layer was bent through 180 degrees. Any cracking of the overcoat layer was observed and listed in Table 1 as Crack; overcoat layers which showed no cracking are rated as Good.

The antifriction properties of the overcoat layer were assessed empirically by its feeling of touch with the finger was evaluated. “Sticky” means the same feeling of touch as silicone rubber surface without an overcoat layer. The same evaluation was carried out after 10 times scrubbing the surface of the overcoat layer with a finger, and after 10 times scrubbing the surface of the overcoat layer with cotton cloth.

The top coat compositions of Examples 9 and 10 were also tested for scratch resistance. The coated fabrics were scratched with a finger nail. The coating was rated Good if no effect of scratching was observed and NG if lifting or removal of the coating from the fabric was observed.

### COMPARATIVE EXAMPLES C1 TO C8

Following the procedures used in Examples 1 to 8, coating compositions were prepared containing some of the ingredients used in the coating compositions of Examples 1 to 8. The formulations are shown in Table 2. A 2% aqueous solution of the bentonite used in comparative examples C6 and C7 had a viscosity of 1 mPa·s, measured as described above.

The coating compositions of comparative examples C1 to C8 were tested in the same way as the coating compositions of Examples 1 to 8. The results are shown in Table 2

TABLE 1
Please add Scratch test: Example 1-8: good

| | Ex 1 | Ex 2 | Ex 3 | Ex 4 | Ex 5 | Ex 6 | Ex 7 | Ex 8 |
|---|---|---|---|---|---|---|---|---|
| Water | 78.4 | 78.4 | 69.3 | 69.3 | 77.2 | 67.2 | 67.2 | 67.2 |
| MCT1 | 1.6 | 1.6 | 0.7 | 0.7 | | | | |
| MCT2 | | | | | 2.8 | 2.8 | 2.8 | |
| Sumecton SA | | | | | | | | 2.8 |
| Talc | 20.0 | | 20.0 | 20.0 | | 20.0 | | |
| Chlorite | | 20.0 | | | 20.0 | | 20.0 | 20.0 |
| PU1 | | | 10.0 | | | 10.0 | 10.0 | 10.0 |
| PO1 | | | | 10.0 | | | | |
| Stability | Good | Good | Good | Good | Good | Good | Good | Good |
| Uniformity | Uniform | Uniform | Uniform | Uniform | Uniform | Uniform | Uniform | Uniform |
| Bending resistance | Good | Good | Good | Good | Good | Good | Good | Good |
| Antifriction Properties Initial | Smooth and | Smooth and | Smooth | Smooth | Smooth and | Smooth | Smooth | Smooth |
| | Slippy | Slippy | and Slippy | and Slippy | Slippy | and Slippy | and Slippy | and Slippy |
| Antifriction Properties after | Smooth and | Smooth and | Smooth | Smooth | Smooth and | Smooth | Smooth | Smooth |
| scrubbing with finger | Slippy | Slippy | and Slippy | and Slippy | Slippy | and Slippy | and Slippy | and Slippy |
| Antifriction Properties after | Slightly | Slightly | Smooth | Smooth | Slightly | Smooth | Smooth | Smooth |
| scrubbing with cotton cloth | Sticky | Sticky | and Slippy | and Slippy | Sticky | and Slippy | and Slippy | and Slippy |
| Scratch test (finger nail) | Good | Good | Good | Good | Good | Good | Good | Good |

TABLE 2
Please add Scratch test: C3, C4 and C6: NG

| | Comp Ex | Comp Ex | Comp Ex | Comp Ex | Comp Ex | Comp Ex | Comp Ex | Comp Ex |
|---|---|---|---|---|---|---|---|---|
| | C1 | C2 | C3 | C4 | C5 | C6 | C7 | C8 |
| Water | 80.0 | 90.0 | 75.0 | 98.0 | 94.0 | 86.0 | 86.0 | 80.0 |
| MCT1 | | | | 2.0 | | | | |
| Bentonite | | | | | | 4.0 | 4.0 | |
| Talc | 20.0 | | | | 5.0 | 10.0 | | |
| Chlorite | | 10.0 | 25.0 | | | | 10.0 | 10.0 |
| PU1 | | | | | | | | 10.0 |
| Sodium polyacrylate | | | | | | | | |
| Stability | NG | Good | Good | Good | NG | Good | Good | Good |
| Uniformity | Patchy | Patchy | Uniform | Uniform | Patchy | Uniform | Patchy | Patchy |
| Bending resistance | Crack | Crack | Crack | Good | Crack | Good | Crack | Crack |
| Antifriction properties initial | — | — | Smooth | Sticky | — | Smooth | — | — |
| | | | and Slippy | | | and Slippy | | |
| Antifriction properties after | — | — | Sticky | Sticky | — | Sticky | — | — |
| scrubbing with finger | | | | | | | | |
| Antifriction properties after | — | — | Sticky | Sticky | — | Sticky | — | — |
| scrubbing with cotton cloth | | | | | | | | |
| Scratch test (finger nail) | | | NG | NG | | NG | | |

### EXAMPLES 9 AND 10

Following the procedure of Example 1, top coat compositions were prepared from the ingredients listed in Table 3. These compositions contained a flame retardant. FR1 is an untreated aluminum hydroxide fine powder of average particle size 1 μm. FR2 is a silane surface treated aluminum hydroxide fine powder of average particle size 1 μm.

The top coat compositions of Examples 9 and 10 were tested as described above, with the difference that instead of application to silicone rubber the coating compositions were applied by gravure roller coating to the coated surface of a woven nylon air bag fabric coated with a coating sold by Milliken & Co. of Spartanburg, S.C., under the trade mark Patina and believed to comprise a hybrid urethane resin comprising urethane polymer blended with an ethylene vinyl acetate copolymer and cured. The top coat was applied at 10 g/m² and heat cured at 140° C.

In addition to the tests described above, the top coat compositions of Examples 9 and 10 were tested for blocking. The coated airbag fabrics are overlapped to have coated surfaces facing each other, and evaluated whether these coated fabric surfaces slide smoothly or not. The coating was rated Good if smooth slide was observed and NG if the surfaces did not slide smoothly or got a scratch

The top coat compositions of Examples 9 and 10 were tested for flammability according to US Federal Motor Vehicles Safety Standards Test FMVSS#302 in a burn test in which a flame was applied to the edge of the fabric and the distance of burning and time of burning were measured. The requirement for passing for the FMVSS#302 standard is a burn rate of 100 mm/min or less.

The results of all the above tests are shown in Table 3.

In a comparative example C9, the silane surface treated aluminum hydroxide fine powder FR2 was used without solid lubricant. The coating composition of comparative example C9 was tested in the same way as the coatings of Examples 9 and 10 and the results are shown in Table 3.

TABLE 3

| | Ex 9 | Ex 10 | Comp Ex C9 |
|---|---|---|---|
| | (weight %) | (weight %) | (weight %) |
| Water | 73.5 | 73.5 | 73.5 |
| MCT1 | 1.5 | 1.5 | 1.5 |
| Talc | 15 | 15 | |
| FR1 | | 10 | 25 |
| FR2 | 10 | | |

Results

| | | | |
|---|---|---|---|
| Stability | Good | Good | Good |
| Uniformity | Uniform | Uniform | Uniform |
| Bending resistance | Good | Good | Good |
| Blocking test | Good | Good | NG |
| Antifriction | Smooth and | Smooth and | Smooth but |
| Properties Initial | Slippy | Slippy | not slippy |
| Antifriction | Smooth and | Smooth and | Slightly sticky |
| Properties after | Slippy | Slippy | |
| scrubbing with finger | | | |
| Flammability(FMVSS#302) | Pass | Pass | Fail |
| Scratch test (Finger nail) | Good | Good | Good |

### EXAMPLES 11, 12 AND 13

Examples 11, 12 and 13 are depicted in Table 4. They were prepared in the same way as the preceding examples and the coating was applied by a knife coating but incorporate a suitable silicone based binder in the form of an emulsion which cures to an elastomeric product (hereafter referred to as a “silicone latex”). The silicone latex additive used in examples 11, 12 and 13 was an oil in water silicone based emulsion having an average particle size of 210 nm and about 55 weight % of non-volatile component(s). The silicone latex used in Examples 11, 12 and 13 comprises the following ingredients:
37.0 weight % of a hydroxylated polydimethylsiloxane having a viscosity of 2,400 mPa·s at 25° C.:
3.0 weight % of a diethylaminoxy group-containing polydimethylsiloxane;
weight % of methyltriethoxysilane,
4.0 weight % of emulsifying agents,
21.3 weight % of water,
33. weight % of colloidal silica (effective component=30 weight %); and
0.7 weight % of diethylamine as a pH adjusting agent.

TABLE 4

| | Example 11 | Example 12 | Example 13 |
|---|---|---|---|
| | (weight %) | (weight %) | (weight %) |
| WATER | 54.30 | 53.80 | 58.90 |
| MCT1 | 0.70 | 1.20 | 1.10 |
| TALC | 25.00 | 25.00 | 25.00 |
| Silicone latex | 20.00 | 20.00 | 15.00 |
| Stability | Good | Good | Good |
| Uniformity | Uniform | Uniform | Uniform |
| Bending | Good | Good | Good |
| resistance | | | |
| Antifriction | Smooth and | Smooth and | Smooth and |
| Properties initial | Slippy | Slippy | Slippy |
| Antifriction | Smooth and | Smooth and | Smooth and |
| Properties after | Slippy | Slippy | Slippy |
| scrubbing with finger | | | |
| Antifriction | Smooth and | Smooth and | Smooth and |
| Properties after | Slippy | Slippy | Slippy |
| scrubbing with cotton cloth | | | |
| Scratch test (finger nail) | Good | Good | Good |

The tests were all carried out as described above and it will be seen from Table 4 that all three examples 11, 12 and 13 produced good results.

### EXAMPLES 14, 15 & 16

The compositions tested in Examples 1415 and 16 are the same as examples 11, 12 and 13 respectively. However like examples 9 and 10 they were applied by gravure roller coating to a pre-coated surface of a woven nylon air bag fabric coated with a silicone rubber coating. The top coat was heat cured at 140° C. Once cured the top coats were analysed and the results are provided in Table 5 below.

One advantage of using the silicone latex instead of the polyurethane (PU) top coat was that the gravure roller was only needing to be cleaned with a water wet cloth after coating test. When PU binder is used, solvents are used for cleaning of the roller.

TABLE 5

| | Example 14 | Example 15 | Example 16 |
|---|---|---|---|
| Top Coat (g/m²) | 13 | 14 | 55 |
| Cleaning: | 5 | 5 | 5 |
| wiping with a water | | | |
| wet cloth | | | |
| Antifriction | Slightly | Smooth and | Smooth and |
| Properties initial | Sticky | Slippy | Slippy |
| Antifriction | Smooth and | Smooth and | Smooth and |
| Properties after | Slippy | Slippy | Slippy |
| scrubbing with finger | | | |
| Removal of talc after | 4 | 5 | 3 |
| scrubbing with cloth | | | |

In the case of Removal of Talc after scrubbing with cloth, the surface of top coat was scrubbed with a cloth and the removal of talc was evaluated by observation of the surface of the wiping cloth visually.

1. An aqueous coating composition for reducing friction and/or blocking at a surface, the composition comprising a solid lubricant and a modified or synthetic clay mineral having thickening properties such that a 2% by weight aqueous dispersion of the modified or synthetic clay mineral thickener has a viscosity of at least 1000 mPa·s.

2. An aqueous coating composition according to claim 1, wherein the solid lubricant is a phyllosilicate.

3. An aqueous coating composition according to claim 2, wherein the solid lubricant is selected from mica, talc, kaolinite, sericite and chlorite.

4. An aqueous coating composition according to claim 1, wherein the solid lubricant is present at 3 to 40% by weight of the aqueous coating composition.

5. An aqueous coating composition according to claim 1, wherein the clay mineral thickener is saponite, bentonite or montmorillonite.

6. An aqueous coating composition according to claim 5, wherein the clay mineral thickener is modified by a water soluble organic polymer.

7. An aqueous coating composition according to claim 6, wherein the water soluble organic polymer contains carboxylate groups.

8. An aqueous coating composition according to claim 7, wherein the water soluble organic polymer is sodium polyacrylate or sodium polymethacrylate.

9. An aqueous coating composition according to claim 7, wherein the water soluble organic polymer is present at 0.1 to 40% by weight based on the clay mineral thickener.

10. An aqueous coating composition according to claim 1, wherein the clay mineral thickener is modified by treatment with an alkylalkoxysilane.

11. An aqueous coating composition according to claim 1, wherein the clay mineral thickener is artificial synthesized saponite.

12. An aqueous coating composition according to claim 1, wherein the modified or synthetic clay mineral thickener is present at from 0.2% to 5% by weight of the aqueous coating composition.

13. An aqueous coating composition according to claim 1, further comprising an organic polymer binder present in aqueous dispersion or a silicone binder in the form of a silicone based aqueous emulsion.

14. An aqueous coating composition according to claim 13, wherein the organic polymer binder comprises a polyurethane or acrylic-modified polyolefin present in aqueous emulsion.

15. An aqueous coating composition according to claim 1, further comprising a flame retardant.

16. An aqueous coating composition according to claim 15, wherein the flame retardant is aluminum trihydrate.

17. A process for preparing an aqueous coating composition for reducing friction and/or blocking at a surface, the process comprising mixing water, a solid lubricant, and a modified or synthetic clay mineral thickener having thickening properties such that a 2% by weight aqueous dispersion of the modified or synthetic clay mineral thickener has a viscosity of at least 1000 mPa·s.

18. A process according to claim 17, wherein a water soluble organic polymer is premixed with the clay mineral to form a modified clay mineral thickener.

19. A process according to claim 18, wherein the clay mineral and water soluble organic polymer are premixed in water and dried.

20-21. (canceled)

22. An air bag coated with an anti-blocking coating comprising a solid lubricant and a modified or synthetic clay mineral having thickening properties such that a 2% by weight aqueous dispersion of the modified clay mineral thickener has a viscosity of at least 1000 mPa·s.

23. A process of coating a substrate to reduce friction and/or blocking, wherein the substrate is coated with an aqueous coating composition comprising a solid lubricant and a modified or synthetic clay mineral having thickening properties such that a 2% by weight aqueous dispersion of the modified clay mineral thickener has a viscosity of at least 1000 mPa·s.

24. A process according to claim 23, wherein a fabric coated with an organic resin is top coated with the aqueous coating composition.

25. An aqueous coating composition according to claim 13, wherein the silicone binder has a dispersed phase, comprising a hydroxylated polydiorganosiloxane and an emulsifying agent, and an aqueous continuous phase, and optionally a silica reinforcing filler.
